(19) United States
(12) Patent Application Publication
(10) Pub. No.: US 2024/0329244 A1
(43) Pub. Date: Oct. 3, 2024

(54) ATTACHMENT FOR ULTRASONIC-WAVE TRANSMITTER/RECEIVER

(71) Applicant: HONDA ELECTRONICS CO., LTD., Aichi (JP)

(72) Inventors: Kenji NAGAREDA, Aichi (JP); Shuichi SANO, Aichi (JP); Kimihiro KUSUNO, Aichi (JP); Shigeo YAMAMOTO, Aichi (JP)

(21) Appl. No.: 17/919,303

(22) PCT Filed: Dec. 22, 2021
(86) PCT No.: PCT/JP2021/047558

§ 371 Date: Oct. 17, 2022

(51) Int. Cl. G01S 15/96; G01S 7/521

(52) U.S. Cl. CPC G01S 15/96; G01S 7/521

(57) ABSTRACT

An attachment for an ultrasonic transducer can be used for changing the directivity characteristics of ultrasonic waves irradiated from a radiation surface depending on the situation, even if there is only one ultrasonic-wave transmitter/receiver. The attachment is adapted to be attached to the ultrasonic transducer and comprises a holding member, a buoyant body, and a directivity-characteristic changing member. The holding member has a holding concave portion that detachably holds the ultrasonic-wave transmitter/receiver. The buoyant body is provided so as to surround the holding member from the outer peripheral side, and is made of a material whose specific gravity is less than that of water and maintains the ultrasonic-wave transmitter/receiver horizontally by the buoyancy acting on itself. The directivity-characteristic changing member is arranged on the side of the acoustic radiation surface of the ultrasonic-wave transmitter/receiver to change the directivity characteristics of the ultrasonic waves irradiated from the acoustic radiation surface.

### TECHNICAL FIELD

The present invention relates to an attachment to be attached to an ultrasonic-wave transmitter/receiver.

### TECHNICAL BACKGROUND

There is a conventionally known ultrasonic-wave transmitter/receiver holding the ultrasonic transducer, suspended by a cable for signal transmission and dropped into the water so that the ultrasonic transducer transmits and receives ultrasonic waves, thus detecting any school of fish present. This ultrasonic-wave transmitter/receiver is used, e.g. for ice fishing such as lake-smelt fishing. The ultrasonic-wave transmitter/receiver is to be inserted into the water through a hole made in the ice when ice fishing.

Incidentally, there is a demand to adjust (change) the directivity of the ultrasonic waves irradiated from the ultrasonic transducer. Conventionally, it has been proposed to use an acoustic lens having a convex or concave surface (see, for example, Patent Documents 1 to 5) and an acoustic window having an opening hole (see, for example, Patent Document 6) as a member for changing the directivity of ultrasonic waves.

### PRIOR ARTS

### Patent Documents

Patent Document 1: Japanese Unexamined Patent Application Publication No. S59-85972 (FIG. 2, 5, 6, etc.)
Patent Document 2: Japanese Unexamined Patent Application Publication No. H5-212355 (claim 2, Paragraphs [0012], [0023], FIGS. 1, 2, etc.)
Patent Document 3: Japanese Unexamined Patent Application Publication No. H10-179582 (Paragraph [0017], FIG. 1, etc.)
Patent Document 4: Japanese Unexamined Patent Application Publication No. 2001-169393 (claims 1, 3, 4, Paragraphs [0010], [0016], FIGS. 1, 4, etc.)
Patent Document 5: Japanese Unexamined Patent Application Publication No. H9-298795 (claim 3, Paragraphs [0035], [0037], FIGS. 6 to 8, etc.)
Patent Document 6: Japanese Unexamined Utility Patent Application Publication No. S52-44038 (Full text of Japanese Unexamined Utility Patent Application Publication No. S48-37659, FIGS. 1 to 3, etc.)

### DISCLOSURE OF THE INVENTION

### Problems to be Solved by the Invention

However, according to the prior arts described in Patent Documents 1 to 6, an acoustic lens or an acoustic window is directly attached to the ultrasonic transducer. In that case, there is a problem that even if the situation changes, the directivity characteristics of the ultrasonic waves cannot be adjusted accordingly.

Further, to improve the detection accuracy of the ultrasonic-wave transmitter/receiver, it is preferable to irradiate (transmit) ultrasonic waves vertically downward with the acoustic radiation surface of the ultrasonic-wave transmitter/receiver in a horizontal state. Conventionally, the acoustic radiation surface is horizontally maintained by the self-weight of the ultrasonic-wave transmitter/receiver. However, the acoustic radiation surface is inclined when the ultrasonic-wave transmitter/receiver is inclined. Then, the direction of the irradiated ultrasonic waves is inclined in the vertical direction. In this case, since the school of fish cannot be detected accurately, there is a problem that an error occurs on the display of the fish finder.

The present invention has been achieved in view of the above problems. The first purpose thereof such an invention is to provide an attachment for an ultrasonic-wave transmitter/receiver, which can change the directivity characteristics according to various situations. The second object is to provide an attachment for an ultrasonic-wave transmitter/receiver, which can keep the ultrasonic-wave transmitter/receiver in a horizontal state to transmit the ultrasonic waves vertically downward, thus improving detection accuracy.

### Means for Solving the Problems

In order to solve the above problems, the first aspect of the present invention refers to an attachment to be attached to an ultrasonic-wave transmitter/receiver, which is suspended from a cable, and houses an ultrasonic transducer in the state of being molded for transmitting and receiving the ultrasonic waves and whose bottom surface is an acoustic radiation surface characterized in that the attachment comprises: a cup-shaped holding member having a holding recess for detachably holding the ultrasonic-wave transmitter/receiver; a buoyant body made of a material having a specific gravity less than that of water, which is provided so as to surround the holding member from the outer peripheral side to keep the ultrasonic-wave transmitter/receiver horizontal by the buoyant force which acts on itself, and a directivity-characteristic changing member arranged on the acoustic radiation surface side of the ultrasonic-wave transmitter/receiver, thus changing the directivity characteristic of the ultrasonic waves emitted from the acoustic radiation surface.

According to the first aspect of the present invention, the ultrasonic wave transmitter/receiver is detachably held in the holding recess of the holding member, and the directivity-characteristic changing member is arranged on the acoustic radiation surface of the ultrasonic-wave transmitter/receiver held in the holding recess. Therefore, even if there is only one ultrasonic-wave transmitter/receiver, it is possible to change the directivity characteristics of the ultrasonic wave irradiated from the acoustic radiation surface according to the situation. Specifically, holding the ultrasonic-wave transmitter/receiver by the holding recess makes it possible to change the directivity characteristics of the ultrasonic waves through the directivity-characteristic changing member. On the other hand, by removing the ultrasonic-wave transmitter/receiver from the holding recess, the directivity of the ultrasonic waves can be adjusted to the original directivity. Further, since the ultrasonic-wave transmitter/receiver is maintained horizontally by the buoyancy acting on the buoyant body, the acoustic radiation surface of the ultrasonic-wave transmitter/receiver also becomes horizontal. As a result, it is possible to transmit ultrasonic waves vertically downward so that the detection accuracy of the ultrasonic-wave transmitter/receiver is improved.

The second aspect of the present invention refers to an attachment for an ultrasonic-wave transmitter/receiver according to the first aspect of the present invention, characterized in that the directivity-characteristic changing member is an acoustic lens having a flat surface and a convex surface located on its opposite side.

According to the second aspect of the present invention, the flat surface of the acoustic lens is used in close contact with the acoustic radiation surface of the ultrasonic-wave transmitter/receiver via a coupling material such as water, thus making the directivity characteristics of the ultrasonic waves wider than the original directivity characteristics. Also, the convex surface includes a spherical surface, a conical surface, or the like.

The third aspect of the present invention refers to an attachment for an ultrasonic-wave transmitter/receiver according to the first aspect of the present invention, characterized in that the directivity-characteristic changing member is an acoustic window used in a state where the ultrasonic-wave transmitter/receiver is mounted, wherein the acoustic window is made of a soundproof material, having an opening hole smaller in area than the acoustic radiation surface.

According to the third aspect of the present invention, when the ultrasonic-wave transmitter/receiver is placed on the acoustic window, the ultrasonic waves irradiated from the acoustic radiation surface pass only through the opening hole of the acoustic window, but do not pass through the acoustic window. Since this opening hole is smaller in area than the acoustic radiation surface and is for narrowing down the acoustic radiation area of the ultrasonic waves, the directional angle of the ultrasonic waves is widened as the ultrasonic waves pass through the opening hole. As a result, the directivity characteristics of the ultrasonic waves can be made wider than the original directivity characteristics depending on the situation.

The fourth aspect of the present invention refers to an attachment for an ultrasonic wave transmitter/receiver according to the third aspect of the present invention, characterized in that a first magnetic material is provided on at least either one of the holding member and the acoustic window, and a second magnetic material that attracts the first magnetic material is provided at a position facing the first magnetic material in the ultrasonic-wave transmitter/receiver, wherein at least either one of the first and second magnetic materials is a permanent magnet.

According to the fourth aspect of the invention, the attachment (holding member and acoustic window) and the ultrasonic-wave transmitter/receiver are attracted to each other by the magnetic force of the permanent magnet and are brought into close contact with each other. As a result, when the ultrasonic-wave transmitter/receiver is lifted, the attachment is less likely to come off from the ultrasonic-wave transmitter/receiver. Also, since the upper surface of the acoustic window can be used in a state of being in close contact with the acoustic radiation surface (bottom surface) of the ultrasonic-wave transmitter/receiver, the directivity characteristics of the ultrasonic wave can be surely made wider.

The fifth aspect of the present invention refers to an attachment for an ultrasonic-wave transmitter/receiver according to the fourth aspect of the present invention, characterized in that a plurality of the first magnetic materials is spaced apart from each other around the opening hole of the acoustic window.

According to the fifth aspect of the present invention, since the plurality of first magnetic materials is spaced apart from each other around the opening hole of the acoustic window, the attachment can be made lighter compared to the case where the first magnetic material is arranged over the entire circumference of the opening hole of the acoustic window. Further, by making the attachment lighter, the buoyancy of the attachment can be sufficiently secured (to the extent that it does not sink).

The sixth aspect of the present invention refers to an attachment for an ultrasonic-wave transmitter/receiver according to any one of the third to fifth aspects of the present invention, characterized in that the holding member, the buoyant body and the acoustic window are made of foamed polyethylene and integrally formed.

According to the sixth aspect of the present invention, since the holding member, the buoyant body and the acoustic window are made of foamed polyethylene, the buoyancy of the holding member, of the buoyant body and of the acoustic window can be set to an appropriate size, for example, to the extent that the water surface reaches the upper surface of the acoustic window in a state where the ultrasonic-wave transmitter/receiver is not held on the holding member. Also, the strength and water resistance of the holding member, of the buoyant body and of the acoustic window can be sufficiently obtained. Further, since the holding member, the buoyant body and the acoustic window which are made of foamed polyethylene have soundproofing performance, it is possible to prevent ultrasonic waves irradiated from the acoustic radiation surface from passing through a portion different from the opening hole of the acoustic window. Since the brittle temperature of the foamed polyethylene is, for example, about −40° C., the holding member, the buoyant body and the acoustic window have high cold resistance. Furthermore, since it is unnecessary to form the holding member, the buoyant body, and the acoustic window separately, the number of parts of the attachment can be reduced, thus making it possible to reduce the manufacturing cost of the attachment.

The seventh aspect of the present invention refers to an attachment for an ultrasonic-wave transmitter/receiver according to any one of the first to fifth aspects of the present invention, characterized in that the directivity-characteristic changing member is detachably held to the holding member and is selected from among various types of directivity characteristic changing members of which at least one of dimensions and shape is different from each other.

According to the seventh aspect of the present invention, even if there is only one ultrasonic-wave transmitter/receiver, a directivity characteristic changing member is selected from among various types of directivity-characteristic changing members depending on the situation and is held by the holding member, thus making it possible to switch the directivity characteristics of the ultrasonic waves variously for actual use.

The eighth aspect of the present invention refers to an attachment for an ultrasonic-wave transmitter/receiver according to any one of the first to seventh aspects of the prevent invention, characterized in that the buoyant body is integrally formed with the holding member.

According to the eighth aspect of the present invention, since it is unnecessary to form the buoyant body and the holding member separately, the number of parts of the attachment can be reduced, thus making it possible to reduce the manufacturing cost of the attachment.

The ninth aspect of the present invention refers to an attachment for an ultrasonic-wave transmitter/receiver according to any one of the first to eighth aspects of the present invention, characterized in that the holding recess holds the directivity characteristic changing member on its lower side and houses and holds the ultrasonic-wave transmitter/receiver on its upper side, wherein the buoyant body is attached so as to surround the outer wall surface of the holding member.

According to the ninth aspect of the present invention, the directivity-characteristic changing member is held on the lower side of the holding recess and the ultrasonic-wave transmitter/receiver is housed and held on the upper side of the holding recess, thus making it possible to stably hold the directivity characteristic changing member and the ultrasonic-wave transmitter/receiver. Also, since the buoyant body is attached so as to surround the outer wall surface of the holding member, the buoyancy acts evenly on the holding member, thus easily eliminating the inclination of the holding member. As a result, the balanced state of the ultrasonic-wave transmitter/receiver held by the holding member in water can be easily stabilized, and the acoustic radiation surface of the ultrasonic-wave transmitter/receiver becomes horizontal, thus making it possible to easily improve the detection accuracy of the ultrasonic-wave transmitter/receiver.

### Effects of the Invention

As described in detail above, according to the first to ninth aspects of the present invention, even if there is only one ultrasonic-wave transmitter/receiver, it can be used by changing directivity characteristics depending on the different situations. Further, keeping the ultrasonic-wave transmitter/receiver horizontal makes it possible to transmit ultrasonic waves vertically downward, further making it possible to improve the detection accuracy of the ultrasonic-wave transmitter/receiver.

### BRIEF DESCRIPTION OF THE DRAWINGS

FIG. 1 is the side view showing an ultrasonic-wave transmitter/receiver of the present invention.

FIG. 2 is the cross-sectional view showing an attachment for an ultrasonic-wave transmitter/receiver according to the first embodiment.

FIG. 3 is the plan view showing an attachment according to the first embodiment.

FIG. 4 is the graph showing the relationship between frequency and full width at half maximum (FWHM) of Examples A1 and A2 and Comparative Example A.

FIG. 5 is the graph showing the relationship between frequency and transmission voltage sensitivity in Examples A1 and A2 and Comparative Example A.

FIG. 6 (a) and FIG. 6 (b) are the graphs showing the relationship between the angle and the transmission voltage sensitivity in sample A.

FIG. 7 (a) and FIG. 7 (b) are the graphs showing the relationship between the angle and the transmission voltage sensitivity in sample B.

FIG. 8 is the cross-sectional view showing an attachment for an ultrasonic-wave transmitter/receiver according to the second embodiment.

FIG. 9 is the plan view showing a holding member according to the second embodiment.

FIG. 10 is a graph showing the relationship between frequency and directional angle in Examples B1 and B2 and Comparative Example B.

FIG. 11 is the graph showing the relationship between frequency and transmission/reception sensitivity in Examples B1 and B2 and Comparative Example B.

FIG. 12 is the plan view showing an attachment for an ultrasonic-wave transmitter/receiver according to the third embodiment.

FIG. 13 is the cross-sectional view showing an attachment according to the third embodiment.

FIG. 14 is the side view showing an ultrasonic-wave transmitter/receiver according to the third embodiment.

FIG. 15 is a bottom view showing an ultrasonic-wave transmitter/receiver according to the third embodiment.

FIG. 16 is the cross-sectional view showing an attachment for an ultrasonic-wave transmitter/receiver according to another embodiment.

FIG. 17 is the cross-sectional view showing an attachment for an ultrasonic-wave transmitter/receiver according to yet another embodiment.

FIG. 18 is the cross-sectional view showing an attachment for an ultrasonic-wave transmitter/receiver according to yet another embodiment.

### MODES FOR CARRYING OUT THE INVENTION

### First Embodiment

Hereinafter, the first embodiment specifying the present invention will be described in detail with reference to the drawings.

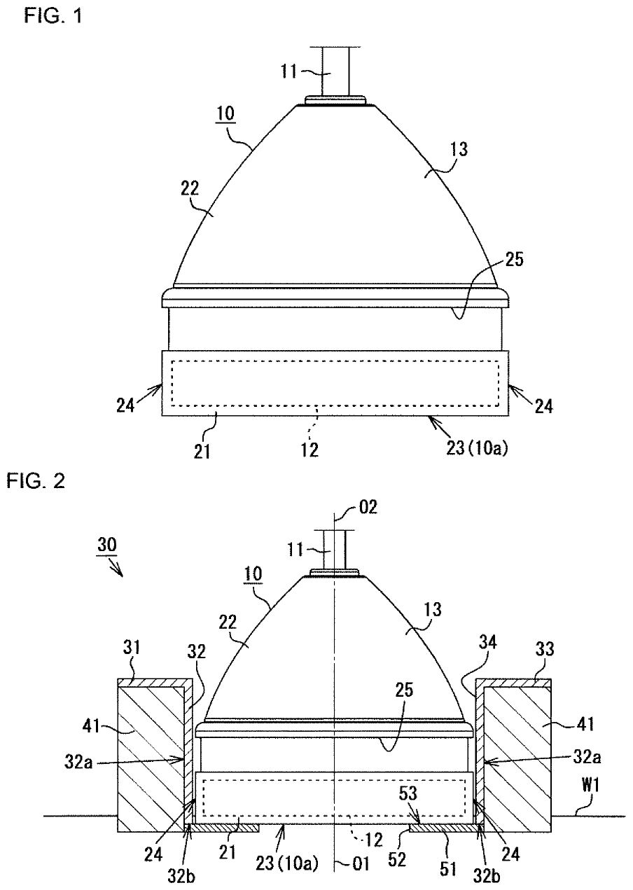

As shown in FIG. 1, the ultrasonic-wave transmitter/receiver 10 of the present embodiment is a device for a fish finder that detects a school of fish existing in water by irradiating ultrasonic waves in water. The ultrasonic-wave transmitter/receiver 10 is used in a state of being suspended from a cable 11. Also, the ultrasonic-wave transmitter/receiver 10 includes an ultrasonic transducer 12 for transmitting/receiving ultrasonic waves, and a case 13 for housing the ultrasonic transducer 12 in a molded state. Since the ultrasonic transducer 12 of the present embodiment is a composite transducer having a piezoelectric element such as a 0-3 composite structure, a 1-3 composite structure, a 2-2 composite structure, or the like, the entire radiation surface has a relatively uniform phase.

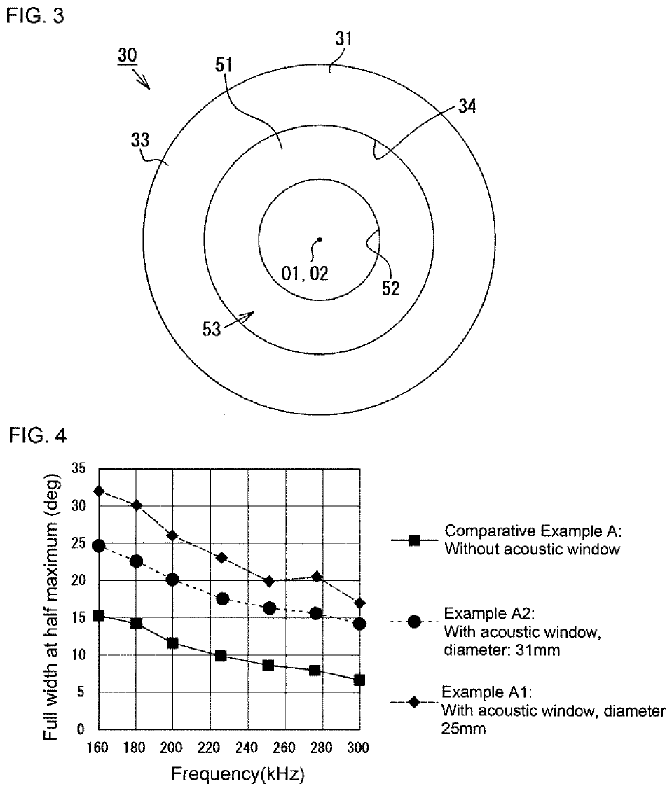

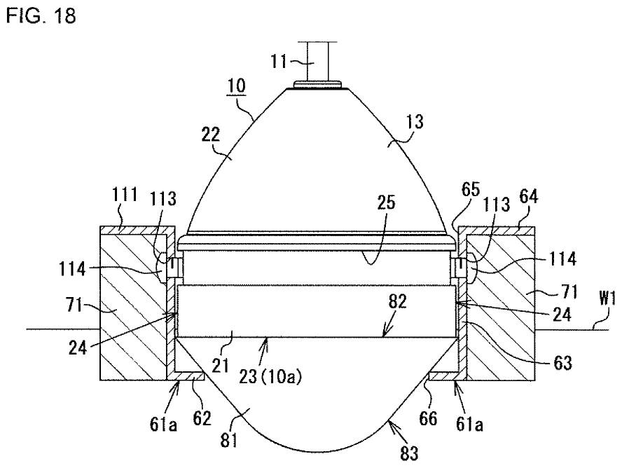

Further, the case 13 has a bell shape with a lower case 21 forming the lower half portion of the case 13 and an upper case 22 forming the upper half portion of the case 13. The lower case 21 is open at its upper end and has a bottom surface 23 and an outer peripheral surface 24 perpendicular to the bottom surface 23. The ultrasonic transducer 12 is housed inside the lower case 21. The outer diameter of the ultrasonic transducer 12 is greater than the inner diameter of the opening hole 52 of the acoustic window 51 shown in FIGS. 2 and 3, and slightly less than the outer diameter of the bottom surface 23. The bottom surface 23 of the lower case 21 is a flat surface and functions as an acoustic radiation surface 10a for irradiating (transmitting) ultrasonic waves. Furthermore, a groove 25 for fitting the screw 114 or the like as shown in FIG. 18 is formed on the outer peripheral surface 24 of the lower case 21. The groove 25 has a rectangular cross-section and extends along the circumferential direction of the cylindrical lower case 21, and is continuously formed over the entire circumference of the lower case 21.

As shown in FIG. 1, the upper case 22 has a shape that opens at the lower end and the outer diameter gradually decreases toward the upper end. A through hole (not shown) for inserting the cable 11 is provided at the upper end of the upper case 22.

The ultrasonic-wave transmitter/receiver 10 of the present embodiment is used in a state of being suspended from the cable 11 when in normal use (see FIG. 1). However, the ultrasonic wave transmitter/receiver 10 can also be used in a state where an attachment 30 (see FIGS. 2 and 3) is attached thereto. Specifically, the attachment 30 includes a holding member 31, a buoyant body 41, and an acoustic window 51 (directivity-characteristic changing member). The holding member 31 is a substantially cylindrical member made of a resin material such as ABS resin or the like and is formed into a cup shape with a cylindrical portion 32 and an upper end portion 33. Then, the inner region of the cylindrical portion 32 becomes a holding recess 34 that detachably holds the ultrasonic-wave transmitter/receiver 10. The inner diameter of the holding recess 34 (cylindrical portion 32) is slightly greater than the outer diameter of the ultrasonic wave transmitter/receiver 10.

A buoyant body 41 is provided so as to surround the holding member 31 from the outer peripheral side. Specifically, the buoyant body 41 is attached so as to surround the outer wall surface 32a by wrapping a strip-shaped sponge around the entire outer wall surface 32a of the cylindrical portion 32. Also, the buoyant body 41 is formed by using a material having a specific gravity less than that of water, such as Styrofoam, polyethylene foam, and polyurethane foam. The buoyant body 41 maintains the holding member 31, the acoustic window 51 and the ultrasonic-wave transmitter/receiver 10 horizontally by the buoyancy acting on the buoyant body 41 itself. Also, the buoyant body 41 has a buoyancy that is efficient to let the water surface W1 reach the upper surface 53 of the acoustic window 51, while the ultrasonic-wave transmitter/receiver 10 is not being held in the holding recess 34.

As shown in FIGS. 2 and 3, the acoustic window 51 is attached to the lower end surface 32b of the cylindrical portion 32 by using double-sided tape (not shown). As a result, the acoustic window 51 is detachably held to the holding member 31. Also, the acoustic window 51 of the present embodiment is a disk-shaped member formed by using a soundproof material (rubber sponge) having a closed-cell structure such as neoprene rubber. An opening hole 52 for adjusting the directivity characteristics of the ultrasonic waves is provided in the center of the acoustic window 51. The opening hole 52 has a circular shape with an area smaller than that of the acoustic radiation surface 10a of the ultrasonic-wave transmitter/receiver 10. As a result, the acoustic window 51 covers the region of the acoustic radiation surface 10a excluding its central portion. The inner diameter of the opening hole 52 is less than the outer diameter of the piezoelectric element constituting the ultrasonic transducer 12. The area of the opening hole 52 is 15% or more and 40% or less as large as the area of the acoustic radiation surface 10a. Also, the amount of deviation between the central axis O1 of the opening hole 52 and the central axis O2 of the ultrasonic-wave transmitter/receiver 10 is 2% or less (0% in this embodiment) as large as the external dimensions of the ultrasonic-wave transmitter/receiver 10. If the amount of deviation is more than 2%, the center of gravity will be biased, and the holding member 31 and the ultrasonic-wave transmitter/receiver 10 will be tilted. In that case, there is a risk that the ultrasonic waves will not travel directly downward.

The acoustic window 51 is used with the ultrasonic-wave transmitter/receiver 10 placed thereon (see FIG. 2). In other words, the acoustic window 51 is arranged on the acoustic radiation surface 10a of the ultrasonic-wave transmitter/receiver 10 and has the function to change the directivity characteristics of the ultrasonic waves irradiated from the acoustic radiation surface 10a.

Next, a method for using the attachment 30 for the ultrasonic-wave transmitter/receiver 10 will be described.

The ultrasonic wave transmitter/receiver 10 of the present embodiment is used for ice fishing such as smelt fishing. In normal ice fishing, the ultrasonic-wave transmitter/receiver 10 is immersed in water while being suspended by the cable 11. Then, the fish school is detected by transmitting and receiving ultrasonic waves by the ultrasonic transducer 12 in the ultrasonic-wave transmitter/receiver 10. Specifically, first, each power of the ultrasonic-wave transmitter/receiver 10 and a liquid crystal monitor (not shown) is turned on. The liquid crystal monitor is used, for example, in a state of being held by a user. In addition, the liquid crystal monitor includes a control device (not shown) that integrally controls the entire device. The control device is composed of a well-known computer including a CPU, a ROM, a RAM, and the like.

Next, the CPU of the control device performs control of the ultrasonic transducer 12 in the ultrasonic-wave transmitter/receiver 10 to output an oscillation signal via the cable 11 so as to drive the ultrasonic transducer 12. At this time, the ultrasonic transducer oscillates, and ultrasonic waves are irradiated (transmitted) into the water from the acoustic radiation surface 10a of the ultrasonic transducer 12 and from the ultrasonic-wave transmitter/receiver 10. Then, when the ultrasonic wave reaches the school of fish, the ultrasonic wave is reflected by the school of fish to become a reflected wave, propagates toward the ultrasonic-wave transmitter/receiver 10, and is input to (received by) the ultrasonic transducer 12. After that, the ultrasonic waves (reflected waves) received by the ultrasonic transducer 12 are converted into received signals and input to the CPU via the cable 11. At this time, the school of fish is detected. Thereafter, when the user turns off the power, the irradiation of ultrasonic waves and reception of the reflected waves are completed.

Meanwhile, there is a desire to detect a school of fish in a broader range than usual. In this case, after attaching an attachment 30 to the ultrasonic-wave transmitter/receiver 10, the attachment 30 is used in a state of being immersed in water (see FIG. 2). Specifically, first, the ultrasonic-wave transmitter/receiver 10 with the acoustic radiation surface 10a facing down is inserted into the holding recess 34 of the holding member 31. The ultrasonic-wave transmitter/receiver 10 is placed on the acoustic window 51 attached to the lower end surface 32b of the holding member 31 (cylindrical portion 32). As a result, the attachment 30 is attached to the ultrasonic-wave transmitter/receiver 10. Next, the ultrasonic-wave transmitter/receiver 10 and the attachment 30 are put into water. At this time, water flows into the holding recess 34 through the opening hole 52 of the acoustic window 51 and enters between the upper surface 53 of the acoustic window 51 and the acoustic radiation surface 10a of the ultrasonic-wave transmitter/receiver 10. When the ultrasonic-wave transmitter/receiver 10 is mounted on the upper surface 53 of the acoustic window 51, the acoustic radiation surface 10a of the ultrasonic-wave transmitter/receiver 10 surely comes into contact with the liquid (here, it comes into contact with water) so that an air reservoir does not hinder the ultrasonic irradiation. Also, the holding member 31 and the ultrasonic-wave transmitter/receiver 10 float on water and are maintained horizontally by the buoyancy acting on the buoyant body 41.

In this state, the CPU of the control device controls to drive the ultrasonic transducer 12 in the ultrasonic-wave transmitter/receiver 10. As a result, the ultrasonic transducer 12 oscillates, and ultrasonic waves are irradiated (transmitted) from the acoustic radiation surface 10a of the ultrasonic transducer 10 into the water. The ultrasonic waves irradiated from the acoustic radiation surface 10a pass only through the opening hole 52 of the acoustic window 51. Since the opening hole 52 is smaller in area than the acoustic radiation surface 10a, the acoustic radiation area of the ultrasonic waves is narrowed, the directional angle of the ultrasonic waves is widened. As a result, the directivity characteristics of the ultrasonic waves become wider than the original directivity characteristics, thus making it possible to detect a school of fish in a wider range than usual.

Next, a method for evaluating the attachment and its results will be described.

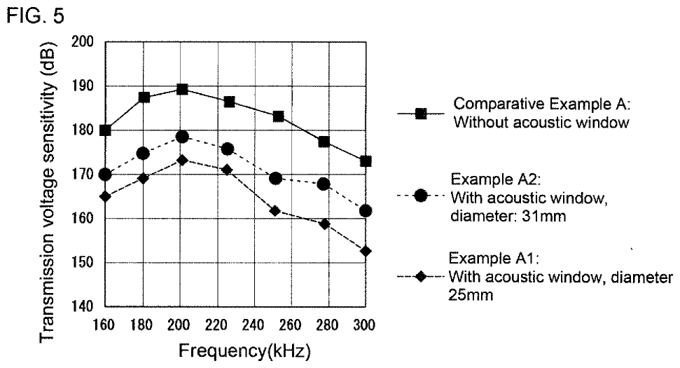

First, a sample for measurement was prepared as follows. An attachment provided with an acoustic window having an opening hole of an inner diameter of 25 mm was prepared and designated as Example A1 (see “♦” in FIGS. 4 and 5). Also, an attachment provided with an acoustic window having an opening hole of an inner diameter of 31 mm was prepared and designated as Example A2 (see “●” in FIGS. 4 and 5). On the other hand, an attachment without an acoustic window was prepared and designated as Comparative Example A (see “▪” in FIGS. 4 and 5).

Next, the directivity characteristics of ultrasonic waves were verified for each measurement sample (Examples A1 and A2 and Comparative Example A). Specifically, ultrasonic waves were emitted from the ultrasonic transducer in the ultrasonic-wave transmitter/receiver to which the attachment was attached. Then, the directivity characteristics of the ultrasonic waves while being irradiated (transmitted) were verified. In addition, the frequency was switched to multiple levels between 160 kHz and 300 kHz, and ultrasonic waves were irradiated at each switched frequency. FIG. 4 is the graph showing verification results of the directivity characteristics of ultrasonic waves.

As a result, it was confirmed that in Comparative Example A which has no acoustic window, when ultrasonic waves are irradiated from the ultrasonic transducer, the directivity characteristics have a relatively narrow full width at half maximum (FWHM) at any frequency. On the other hand, it was confirmed that in Examples A1 and A2, when ultrasonic waves are irradiated from one opening hole in the center of the acoustic window, the directivity characteristics have a wider full width at half maximum FWHM than that of Comparative Example A at any frequency. Especially, it was confirmed that Example A1, in which the inner diameter of the opening hole is 25 mm, has directivity characteristics with a wider full width at half maximum (FWHM) at all frequencies than that of Example A2, in which the inner diameter of the opening hole is 31 mm.

Therefore, it was confirmed that if the ultrasonic waves are irradiated from the opening hole of the acoustic window, the directional angle of the ultrasonic waves is widened, and the detection range of the ultrasonic transducer is also widened. Furthermore, it was confirmed that if the inner diameter of the opening hole is made smaller, the directional angle of the ultrasonic waves is widened, and the detection range of the ultrasonic transducer is also widened.

Next, a voltage was applied to the ultrasonic transducer of each measurement sample (Examples A1, A2, and Comparative Example A) to obtain a transmission voltage sensitivity at a position that is on the radiation center axis line of the ultrasonic transducer and one meter away from the ultrasonic transducer. Specifically, first, ultrasonic waves were perpendicularly irradiated (transmitted) to the surface of a reflector located one meter away from the ultrasonic transducer. In addition, the frequency was switched to multiple levels between 160 kHz and 300 kHz, and ultrasonic waves were irradiated at each switched frequency. Then, the ultrasonic waves reflected on the surface of the reflector were received by the ultrasonic transducer after the lapse of the predetermined time after completion of transmission, thus generating voltage signals at both electrodes of the ultrasonic transducer. Then, the voltage amplitude, while the ultrasonic waves were transmitted and received by the ultrasonic transducer, was measured with an oscilloscope, thus calculating the transmission/reception sensitivity based on such measurement results. The transmission/reception sensitivity is the ratio of the reception voltage amplitude V2 to the transmission voltage amplitude V1 and is calculated from the formula 20×log (V2/V1). Next, based on the arithmetically calculated transmission/reception sensitivity, the transmission voltage sensitivity was calculated. The transmission voltage sensitivity is calculated from the formula (transmission/reception sensitivity)—(microphone sensitivity). The results of Examples A1, A2, and Comparative Example A are shown in FIG. 5.

As a result, it was confirmed that the transmission voltage sensitivity of Examples A1 and A2, which have wide directional angles to irradiate the ultrasonic waves from the opening hole of the acoustic window, was lower at all frequencies than that of Comparative Example A, which has a narrow directional angle due to lack of opening hole. It was also confirmed in Examples A1 and A2 that the transmission voltage sensitivity of Example A1 which has a wide directional angle because the inner diameter of the opening hole is relatively small (inner diameter: 25 mm), was lower than that of Example A2 which has a narrow directional angle because the inner diameter of the opening hole is relatively large (inner diameter: 31 mm). Moreover, it was confirmed in each of Examples A1, A2, and Comparative Example A that the transmission voltage sensitivity was maximized at the frequency of 200 kHz. From the above, it was confirmed that if the inner diameter of the opening hole of the acoustic window is made smaller, the directional angle of the ultrasonic waves can be widened, but the sensitivity is lowered.

In order to solve this problem, for example, it is conceivable to adjust the gain of the receiver (not shown) so that the fish shadows are equally reflected and displayed on the screen of the fish finder. Specifically, when the reception voltage at the center of the ultrasonic transducer is lowered by 20 dB, for example, the amplification factor is increased by 20 dB. In this manner, even if the ultrasonic directional angle is widened by inserting the acoustic window, it is possible to obtain a response to a wider range of fish shadows.

Next, a method for evaluating the ultrasonic transducer and its results will be described.

First, a sample for measurement was prepared as follows. An annular ultrasonic transducer was prepared and designated as Sample A. Also, an ultrasonic transducer having a piezoelectric element with a 2-2 composite structure was prepared and designated as Sample B.

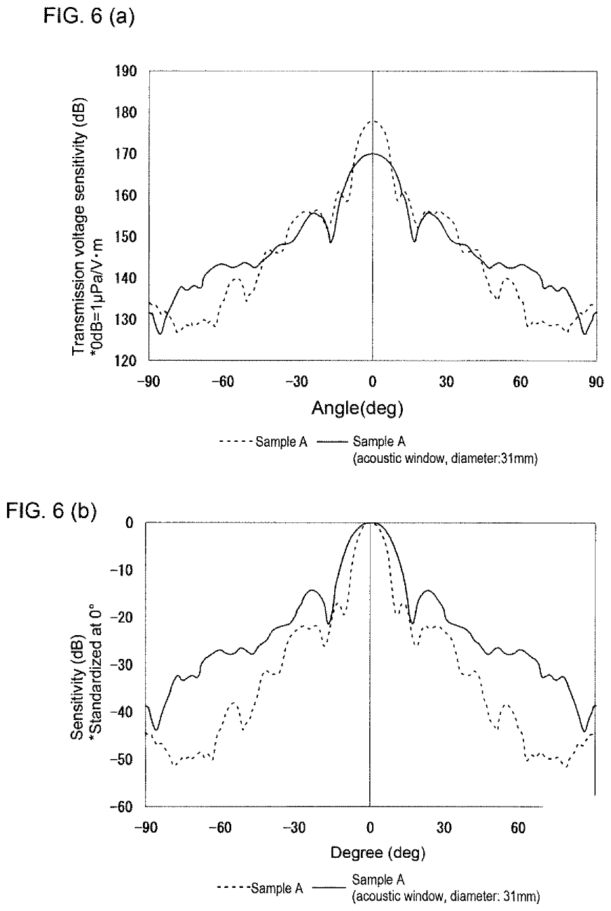

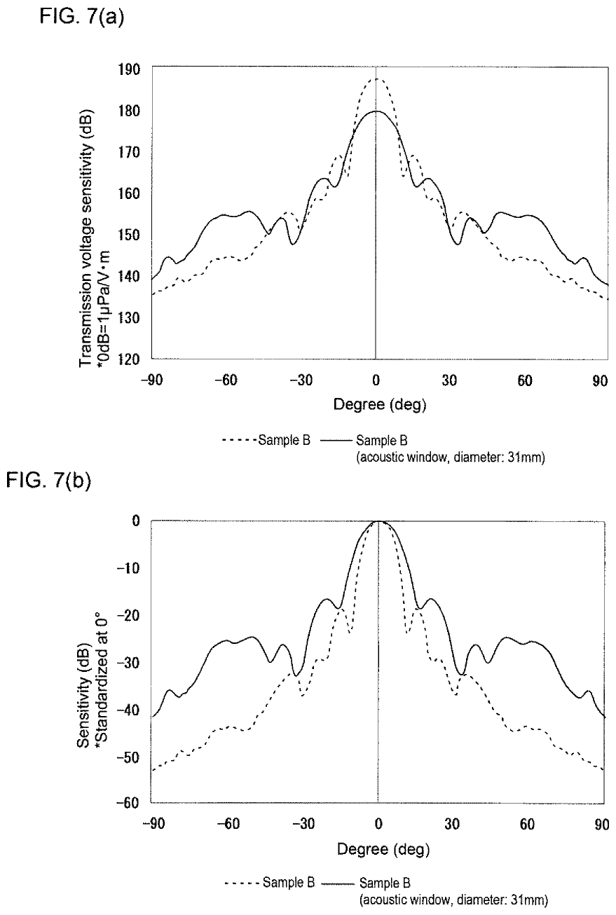

Next, the directivity characteristics of the ultrasonic transducer were verified for each measurement sample (Samples A and B). Specifically, first, an ultrasonic transducer suspended from a crane was placed into a water tank. Also, a microphone was installed at a position that is one meter away from the ultrasonic transducer in the water tank. Then, the angle of the ultrasonic transducer was changed in the range of −90° to 0° while the ultrasonic waves of 200 kHz were being irradiated from the ultrasonic transducer. Also, such irradiated ultrasonic waves are received by the microphone. Then, the reception voltage of the microphone was measured with an oscilloscope, and such a measured reception voltage was corrected by the acoustic-pressure calibration value of the microphone. After that, the transmission/reception sensitivity was calculated based on the corrected reception voltage, and the directivity characteristic data of the transmission voltage sensitivity in the range of −90° to 0° was calculated (obtained) based on the arithmetically calculated transmission/reception sensitivity. Further, the directivity characteristic data of the transmission voltage sensitivity in the range of 0° to 90° was acquired by inverting the acquired directivity characteristic data. The results of Sample A are shown by a dashed line in FIG. 6(a) and the results of Sample B are shown by a dashed line in FIG. 7(a).

After that, a sponge (acoustic window) having an opening hole with an inner diameter of 31 mm was attached to the ultrasonic transducer of each measurement sample. Then, in this state, the same processing as in the case where the sponge is not attached was performed to obtain the directivity characteristic data of transmission voltage sensitivity in the range of −90° to 90°. The results of Sample A are indicated by a solid line in FIG. 6(a) and the results of Sample B are indicated by a solid line in FIG. 7(a). FIG. 6(b) shows the results of Sample A when the center sensitivity (transmission voltage sensitivity at 0°) is normalized to 0 dB and FIG. 7(b) shows the results of Sample B when the center sensitivity is normalized to 0 dB.

As a result, it was confirmed that the effect of expanding the directional angle by the acoustic window can be obtained in each of the ultrasonic transducers of samples A and B, that is, the transmission/reception sensitivity does not easily decrease even when the angle (absolute value of angle) is large. (See FIGS. 6(b) and 7(b)). However, it was also confirmed that the center sensitivity was lowered by nearly 8 dB by providing the acoustic window (see FIGS. 6(a) and 7(a)).

Therefore, according to the present embodiment, the following effects can be obtained.
(1) According to an attachment 30 for the ultrasonic-wave transmitter/receiver 10 of the present embodiment, the ultrasonic-wave transmitter/receiver 10 is held in the holding recess 34 of the holding member 31, and an acoustic window 51 is arranged on the acoustic radiation surface 10a of the ultrasonic-wave transmitter/receiver 10 held in the holding recess 34. In this case, even if there is only one ultrasonic-wave transmitter/receiver 10, it is possible to change the directivity characteristics of the ultrasonic waves irradiated from the acoustic radiation surface 10a depending on the situation. Specifically, when holding the ultrasonic-wave transmitter/receiver 10 in the holding recess 34, the directivity characteristics (directional angle) of the ultrasonic waves can be widened by using the acoustic window 51. On the other hand, when removing the ultrasonic-wave transmitter/receiver 10 from the holding recess 34, the directivity characteristic of ultrasonic waves can be restored to the original directivity characteristics.

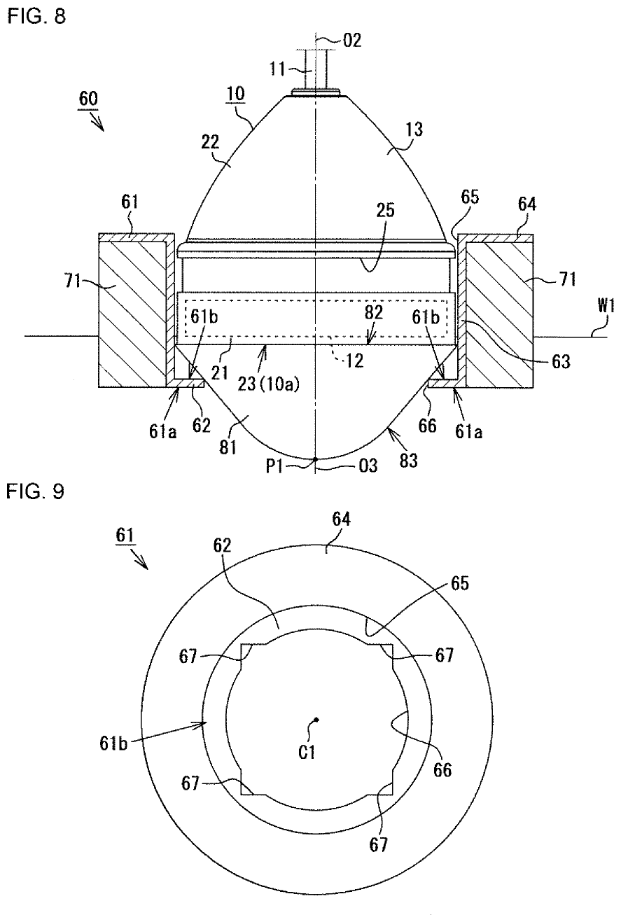

In addition, since the buoyant body 41 is provided so as to surround the holding member 31 from the outer peripheral side simply by winding a strip-shaped sponge around the cylindrical portion 32 of the holding member 31, the ultrasonic-wave transmitter/receiver 10 can be kept horizontal by the buoyancy acting on 41, and the acoustic radiation surface 10a of the ultrasonic-wave transmitter/receiver 10 can be made horizontal without making the configuration complicated. As a result, ultrasonic waves can be transmitted vertically downward, thus improving the detection accuracy of the ultrasonic-wave transmitter/receiver 10.
(2) In the present embodiment, when the ultrasonic-wave transmitter/receiver 10 is placed on the acoustic window 51, ultrasonic waves irradiated from the acoustic radiation surface 10a pass only through the opening hole 52 of the acoustic window 51 but do not pass through the acoustic window 51 which is a soundproof material. The area of the opening hole 52 is smaller than that of the acoustic radiation surface 10a and serves to narrow the acoustic radiation area of the ultrasonic waves. Thus, the directional angle of the ultrasonic waves becomes wider as the ultrasonic waves pass through the opening hole 52. As a result, the directivity characteristics of the ultrasonic waves become wider than the original directivity characteristics, thus making it possible to detect a school of fish in a wider range than usual.
(3) The acoustic window 51 of the present embodiment is attached to the lower end surface 32b of the cylindrical portion 32 of the holding member 31 and is detachably held on the holding member 31. Therefore, by replacing the acoustic window 51 with another acoustic window that has an opening hole 52 of different inner diameters, the directivity characteristics of the ultrasonic waves can be changed in various ways, even if there is only one ultrasonic-wave transmitter/receiver 10.
(4) In this embodiment, the acoustic window 51 that changes the directivity characteristics of ultrasonic waves is used as a directivity-characteristic changing member. This acoustic window 51 is formed simply by providing an opening hole 52 in a disk-shaped rubber sponge. If it is used as the directivity-characteristic changing member, the manufacturing cost of the attachment 30 will be less than in the case where e.g., an acoustic lens 81 is used (see FIG. 8).
(5) According to the present embodiment, the upper case 22 constituting the upper half of a case 13 is shaped not to get caught, and a groove 25 formed in the lower case 21 constituting the lower half of the case 13 is shaped not to protrude from the lower case 21. Therefore, the fishing line is less likely to get entangled in the case 13, particularly during normal ice fishing.

### Second Embodiment

Hereinafter, the second embodiment embodying the present invention will be described with reference to the drawings. The descriptions here will focus on the parts different from the first embodiment. This embodiment differs from the first embodiment with respect to the structure of the attachment.

Specifically, as shown in FIG. 8, an attachment 60 of the present embodiment includes a holding member 61, a buoyant body 71, and an acoustic lens 81 (directivity-characteristic changing member). As shown in FIGS. 8 and 9, the holding member 61 is a substantially cylindrical member made of resin material and is formed into a cup shape with a bottom portion 62, a cylindrical portion 63, and an upper-end portion 64. A space defined by the bottom portion 62 and by the cylindrical portion 63 becomes a holding recess 65 that can detachably hold the ultrasonic wave transmitter/receiver 10.

In addition, one fitting hole 66 is provided on the bottom portion 62 of the holding member 61. The fitting hole 66 has a circular shape and is provided in the center of the bottom portion 62. The fitting hole 66 is for fitting the convex surface 83 of the acoustic lens 81 with the flat surface 82 facing up and then protruding downward from the bottom surface 61a (see FIG. 8) of the holding member 61. At this time, the outer peripheral portion of the acoustic lens 81 is supported from below by the bottom portion 62. The acoustic lens 81 is detachably held to the holding member 61. Further, by widening a part of the fitting hole 66, four water supply/discharge holes 67 are formed. Each water supply/discharge hole 67 has a corner portion on the outer peripheral side of the bottom portion 62. The water supply/discharge holes 67 are arranged at equal angular intervals (90° intervals) with the center C1 (see FIG. 9) of the fitting hole 66 as a reference. Each water supply/discharge hole 67 is for supplying water into the holding recess 65 and discharging the water from there to the outside of the holding member 61.

As shown in FIG. 8, the buoyant body 71 has a buoyancy that is sufficient to make the water surface W1 reach the flat surface 82 of the acoustic lens 81 in a state where the ultrasonic-wave transmitter/receiver 10 is not being held in the holding recess 65. Also, the acoustic lens 81 is a substantially conical-shaped member made of urethane resin. On the other hand, the area of the acoustic radiation surface 10a of the ultrasonic wave transmitter/receiver 10 is made of a molding material such as rubber, urethane resin or the like. Therefore, the acoustic characteristic impedance of the acoustic lens 81 is approximately equal to the acoustic characteristic impedance of the molding material. The acoustic velocity of ultrasonic waves propagating in the acoustic lens 81 is different from the acoustic velocity of ultrasonic waves propagating into water.

The acoustic lens 81 also has a flat surface 82 and a convex surface 83 located on its opposite side. The outer diameter of the flat surface 82 is greater than the outer diameter of the fitting hole 66 and equal to the outer diameter of the acoustic radiation surface 10a. For this reason, the area of the flat surface 82 is equal to the area of the acoustic radiation surface 10a. Furthermore, the outer diameter of the flat surface 82 is slightly greater than the outer diameter of the ultrasonic transducer 12 housed in the lower case 21 of the ultrasonic-wave transmitter/receiver 10. The tip region of the convex surface 83 (the region including the vertex P1 of the acoustic lens 81) is spherical, and the convex surface 83 except for the tip region is an inclined surface. The entire spherical surface forming the convex surface 83 and a part of the inclined surface forming the convex surface 83 protrude downward from the bottom surface 61a of the holding member 61. A part of the inclined surface is supported by the opening end of the fitting hole 66 on the side of the upper surface 61b. Furthermore, the amount of deviation between the central axis O3 (the axis passing through the vertex P1) of the acoustic lens 81 and the central axis O2 of the ultrasonic-wave transmitter/receiver 10 is 2% or less of the outer dimension of the ultrasonic wave transmitter/receiver 10 (amount of the deviation in this embodiment: 0%).

As shown in FIG. 8, the holding recess 65 of the holding member 61 holds the acoustic lens 81 on the lower side and accommodates and holds the ultrasonic-wave transmitter/receiver 10 on the upper side. The acoustic lens 81 is arranged on the acoustic radiation surface 10a of the ultrasonic-wave transmitter/receiver 10 and has the function of changing the directivity characteristics of the ultrasonic waves irradiated from the acoustic radiation surface 10a.

Next, a method for using the attachment 60 will be described.

In normal ice fishing, the ultrasonic-wave transmitter/receiver 10 is immersed in water while being suspended by the cable 11. Schools of fish are detected by ultrasonic-wave transmission and reception of the ultrasonic transducer 12 in the ultrasonic-wave transmitter/receiver 10.

There is also another demand for detecting schools of fish in a wider range than usual by fixing the ultrasonic-wave transmitter/receiver 10 to the attachment 60 and by using it in the state of being immersed in water (see FIG. 8). Specifically, first, the convex surface 83 of the acoustic lens 81 with the flat surface 82 facing upward is fitted into the fitting hole 66 provided on the holding member 61. As such, the acoustic lens 81 is held on the lower side of the holding recess 65 of the holding member 61. Next, the ultrasonic-wave transmitter/receiver 10 with the acoustic radiation surface 10a facing downward is inserted into the holding recess 65. Then, the ultrasonic-wave transmitter/receiver 10 is placed on the flat surface 82 of the acoustic lens 81 that is fitted into the fitting hole 66. As a result, the ultrasonic-wave transmitter/receiver 10 is housed and held in the holding recess 65, and the attachment 60 is attached to the ultrasonic-wave transmitter/receiver 10.

Next, the ultrasonic-wave transmitter/receiver 10 and the attachment 60 are put into water. At this time, water flows into the holding recess 65 from the four-water supply/discharge holes 67 provided in the holding member 61, and then enters between the flat surface 82 of the acoustic lens 81 and the acoustic radiation surface 10a of the ultrasonic-wave transmitter/receiver 10. As a result, the flat surface 82 comes into close contact (acoustically coupled) to the acoustic radiation surface 10a via the coupling material (e.g., water in this embodiment).

In this state, the ultrasonic transducer 12 in the ultrasonic wave transmitter/receiver 10 is driven to irradiate (transmit) ultrasonic waves from the acoustic radiation surface 10a into the water. The directional angle of the ultrasonic waves irradiated from the acoustic radiation surface 10a becomes wider while it is passing through the acoustic lens 81. As a result, the directivity characteristics of the ultrasonic waves become wider than the original directivity characteristics, thus making it possible to detect a school of fish in a wider range than usual.

Next, a method for evaluating the attachment and its results will be described.

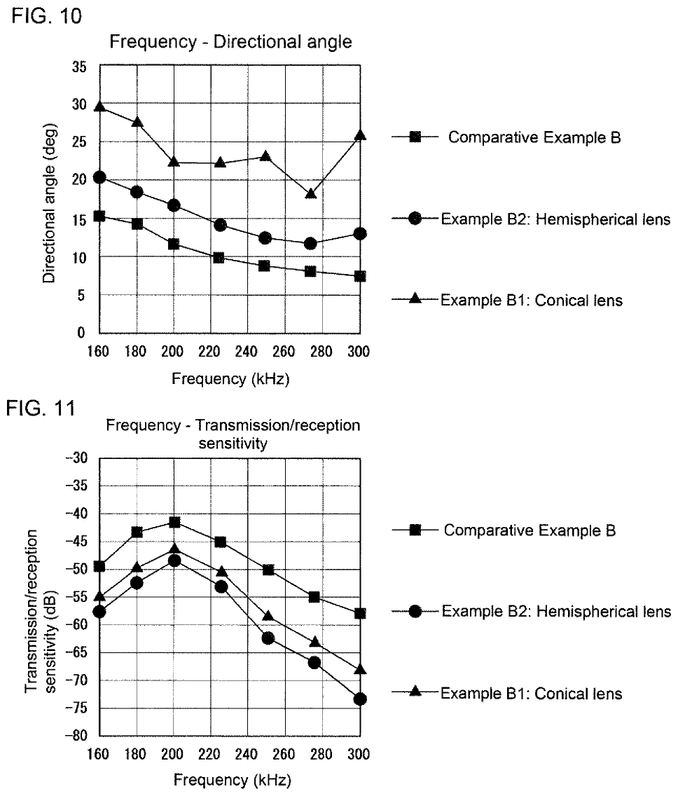

First, a sample for measurement was prepared as follows. An attachment provided with a conical acoustic lens (conical lens) was prepared and designated as Example B1 (see “▴” in FIGS. 10 and 11). Also, an attachment provided with a hemispherical acoustic lens (hemispherical lens) was prepared and designated as Example B2 (see “●” in FIGS. 10 and 11). On the other hand, an attachment without an acoustic lens was prepared and designated as Comparative Example B (see “▪” in FIGS. 10 and 11).

Next, the directivity characteristics of ultrasonic waves were verified for each measurement sample (Examples B1 and B2 and Comparative Example B). Specifically, ultrasonic waves were emitted from the ultrasonic transducer in the ultrasonic-wave transmitter/receiver to which the attachment was attached. Then, the directivity characteristics of the ultrasonic waves while being irradiated (transmitted) were verified. In addition, the frequency was switched to multiple levels between 160 kHz and 300 kHz, and ultrasonic waves were irradiated at each switched frequency. FIG. 10 is the graph showing verification results of the directivity characteristics of ultrasonic waves.

As a result, it was confirmed that in Comparative Example B which has no acoustic lens, when ultrasonic waves are irradiated from the ultrasonic transducer, a directivity characteristic with a relatively narrow directional angle is obtained at any frequency. On the other hand, it was confirmed that in Examples B1 and B2, when ultrasonic waves are irradiated via the acoustic lens, the directivity characteristic with a wider directional angle than Comparative Example B is obtained at any frequency. In particular, it was confirmed that in Example B1 using a conical acoustic lens, a directivity characteristic with a wider directional angle than in Example B2 using a hemispherical acoustic lens is obtained at all frequencies.

Therefore, it was confirmed that when ultrasonic waves were irradiated through the acoustic lens, the directional angle of the ultrasonic waves is widened, and that the detection range of the ultrasonic transducer is also widened. It was also confirmed that using a conical acoustic lens widens the directional angle of the ultrasonic waves and that the detection range of the ultrasonic transducer is also widened.

Next, a voltage was applied to the ultrasonic transducer of each measurement sample (Examples B1, B2, and Comparative Example B) to obtain a transmission/reception sensitivity at a position that is on the radiation center axis line of the ultrasonic transducer and at the vertically lower position of the ultrasonic transducer. Specifically, first, ultrasonic waves were perpendicularly irradiated (transmitted) to the surface of a reflector located away from the ultrasonic transducer. In addition, the frequency was switched to multiple levels between 160 kHz and 300 kHz, and ultrasonic waves were irradiated at each switched frequency. The ultrasonic waves reflected on the surface of the reflector were received by the ultrasonic transducer after the lapse of the predetermined time after completion of transmission, thus generating voltage signals at both electrodes of the ultrasonic transducer. Then, the voltage amplitude, while the ultrasonic waves were transmitted and received by the ultrasonic transducer, was measured with an oscilloscope, thus calculating the transmission/reception sensitivity based on such measurement results. The results of Examples B1, B2, and Comparative Example B are shown in FIG. 11.

As a result, it was confirmed that the transmission/reception sensitivity of Examples B1 and B2, which have a wide directional angle for irradiating ultrasonic waves through an acoustic lens, is lower at all frequencies than that of Comparative Example B, which has a narrow directional angle due to lack of an acoustic lens. It was also confirmed in Examples B1 and B2 that the transmission/reception sensitivity of Examples B1, which has a relatively wide directional angle due to the use of a conical acoustic lens, was higher than that of Example B2, which has a relatively narrow directional angle due to the use of a hemispherical acoustic lens. Moreover, in all Examples B1, B2, and Comparative Example B, it was confirmed that the transmission/reception sensitivity is maximized when the frequency is 200 kHz. From the above, it was confirmed that using an acoustic lens makes it possible to widen the directional angle of ultrasonic waves but lower the sensitivity. It is considered that a practical level of sensitivity can be obtained by selecting an appropriate material for forming the acoustic lens.

Therefore, according to this embodiment, the following effects can be obtained.
(6) According to the attachment 60 for the ultrasonic-wave transmitter/receiver 10 of the present embodiment, the ultrasonic-wave transmitter/receiver 10 is held in the holding recess 65 of the holding member 61, and the acoustic lens 81 is arranged on the acoustic radiation surface 10a of the ultrasonic-wave transmitter/receiver 10 held in the holding recess 65. In this case, even if there is only one ultrasonic-wave transmitter/receiver 10, it is possible to change the directivity characteristics of the ultrasonic waves irradiated from the acoustic radiation surface 10a according to the situation. Specifically, the directivity characteristics (directional angle) of the ultrasonic waves can be widened by using the acoustic lens 81 while the ultrasonic-wave transmitter/receiver 10 is being held in the holding recess 65. On the other hand, by removing the ultrasonic-wave transmitter/receiver 10 from the holding recess 65, the directivity characteristics of ultrasonic waves can be restored to the original directivity characteristics.
(7) According to the present embodiment, the fitting hole 66 and the water supply/discharge hole 67 are provided on the bottom portion 62 of the holding member 61. In this case, when the attachment 60 attached to the ultrasonic-wave transmitter/receiver 10 is immersed in water, the water is supplied into the holding member 61 through the water supply/discharge hole 67, thus infiltrating between the acoustic radiation surface 10a of the ultrasonic-wave transmitter/receiver 10 and the flat surface 82 of the acoustic lens 81. As a result, since the ultrasonic-wave transmitter/receiver 10 and the acoustic lens 81 can be used in a state of being in close contact with each other through water that serves as a coupling material, so as to make the directivity characteristics of the ultrasonic waves wider than the original directivity characteristics. Moreover, when the attachment 60 is pulled up from the water, the water can be smoothly discharged out of the holding member 61 through the water supply/discharge hole 67.
(8) According to the present embodiment, since the conical acoustic lens 81 is used as the directivity-characteristic changing member for changing the directivity characteristic of the ultrasonic waves, it is possible to make the directional angle wider than the case where e.g., a hemispherical acoustic lens is used (see FIG. 10). Suppose the acoustic lens 81 is simply conical. In that case, there is a problem that the sensitivity, at a position that is on the central axis O3 of the acoustic lens 81 as well as vertically below the acoustic lens 81, is lowered. Moreover, since it is difficult to form the tip of the cone with high precision, there is also another problem that variation in product quality may increase. Therefore, all these problems can be resolved in this embodiment since the tip region of the convex surface 83 of the acoustic lens 81 is spherical.
(9) According to the present embodiment, the acoustic lens 81 is used as a directivity changing member that changes the directivity characteristics of ultrasonic waves. If this acoustic lens 81 is used, it is possible to widen the directional angle of the ultrasonic waves, but there is a problem that the sensitivity is lowered. However, suppose an appropriate material is selected as the material for forming the acoustic lens 81. In that case, the sensitivity can be improved more than the case where the acoustic window 51 (see FIGS. 2 and 3), for example, is used as the directivity-characteristic changing member.

### Third Embodiment

A third embodiment embodying the present invention will be described below with reference to the drawings. Here, the description will focus on the portions that are different from the first embodiment. This embodiment differs from the first embodiment in the removable structure of the ultrasonic-wave transmitter/receiver with respect to the attachment.

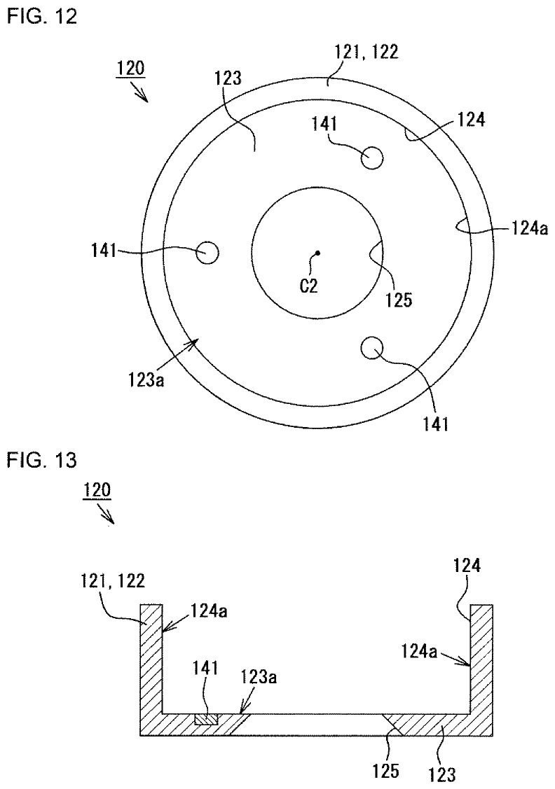

Specifically, as shown in FIGS. 12 and 13, the attachment 120 of the present embodiment includes a holding member 121, a buoyant body 122, and an acoustic window 123 (directivity characteristic changing member). The holding member 121, the buoyant body 122, and the acoustic window 123 are made of foamed resin such as foamed polyethylene in which specific gravity is less than that of water and are integrally formed in a cup shape. A space formed by the acoustic window 123 and the holding member 121 (the buoyant body 122) serves as a holding recess 124 that detachably holds the ultrasonic-wave transmitter/receiver 130. The attachment 120 has a buoyancy sufficient to make the water surface W1 (see FIG. 2) reach the upper surface 123a of the acoustic window 123 in a state where the ultrasonic-wave transmitter/receiver 130 is not being held in the holding recess 124.

A circular opening hole 125 for adjusting the directivity characteristics of the ultrasonic waves is provided in the center of the acoustic window 123. The opening hole 125 has a shape in which its inner diameter gradually increases toward the lower surface 123b of the acoustic window 123. The inner wall surface of the opening hole 125 is inclined by about 45 degrees with respect to the lower surface 123b of the acoustic window 123. Furthermore, three pieces of permanent magnets 141 (first magnetic material) having a circular shape in planner view are provided around the opening hole 125 of the acoustic window 123. A neodymium magnet, for example, is used as the permanent magnet 141 of the present embodiment. Each permanent magnet 141 is embedded in the acoustic window 123 and fixed with an adhesive, and its surface (upper surface) is flush with the upper surface 123a of the acoustic window 123. The permanent magnets 141 are spaced apart from each other on the upper surface 123a of the acoustic window 123. Specifically, the permanent magnets 141 are arranged at equal angular intervals (120° intervals) with the center C2 (see FIG. 12) of the aperture 125 as a reference.

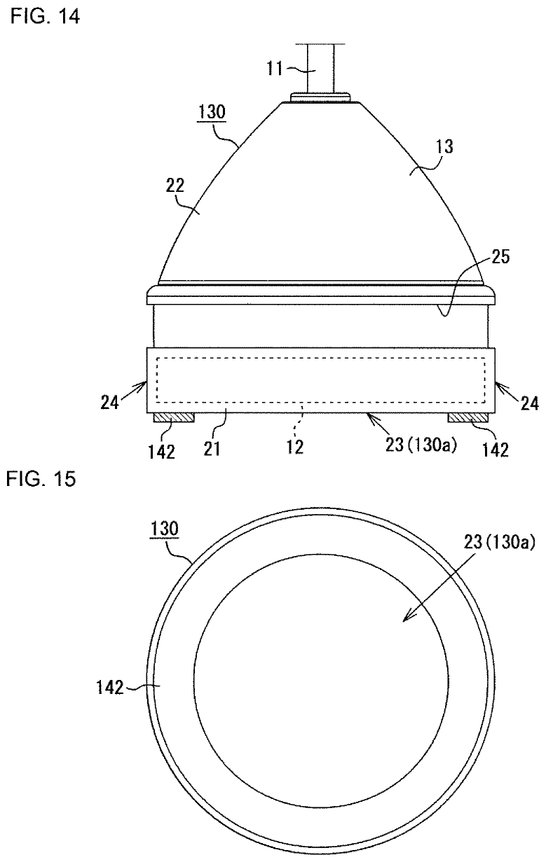

On the other hand, according to the ultrasonic-wave transmitter/receiver 130 as shown in FIGS. 14 and 15, an annular metal plate 142 (second magnetic material) that attracts the permanent magnet 141 is attached at a position facing each permanent magnet 141, more specifically, at the outer peripheral portion of the acoustic radiation surface 130a of the ultrasonic-wave transmitter/receiver 130. The metal plate 142 is arranged outside the piezoelectric elements constituting the ultrasonic transducer 12. Examples of materials for forming the metal plate 142 of the present embodiment include ferritic stainless steel, Fe—Ni alloys, Fe—Si alloys, iron, and the like.

Next, a method for using the attachment 120 will be described.

To detect a school of fish in a wider range than usual, the attachment 120 is first attached to the ultrasonic transducer 130a, then used in a state of being immersed in water. Specifically, first, the ultrasonic-wave transmitter/receiver 130 with the acoustic radiation surface 130 facing downward is inserted into the holding recess 124 of the holding member 121, and then the ultrasonic-wave transmitter/receiver 130 is placed on the upper surface 123a of the acoustic window 123. At this time, since the permanent magnet 141 on the attachment 120 and the metal plate 142 on the ultrasonic transducer 130 are attracted to each other by the magnetic force of the permanent magnet 141, the attachment 120 and the ultrasonic-wave transmitter/receiver 130 are closely contacted to each other. As a result, the attachment 120 is attached to the ultrasonic transducer 130. After that, the ultrasonic-wave transmitter/receiver 130 and the attachment 120 are put into the water, and ultrasonic waves are irradiated (transmitted) from the acoustic radiation surface 130a of the ultrasonic-wave transmitter/receiver 130 into the water, thus making it possible to detect a school of fish.

Therefore, according to the present embodiment, the following effects can be obtained.
(10) According to the present embodiment, the attachment 120 and the ultrasonic-wave transmitter/receiver 130 are attracted to each other by the magnetic force of the permanent magnet 141 and come into close contact with each other. As a result, even if the ultrasonic-wave transmitter/receiver 130 is pulled up by holding the cable 11, the attachment 120 is less likely to fall off from the ultrasonic-wave transmitter/receiver 130. In addition, since the upper surface 123a of the acoustic window 123 can be used in close contact with the acoustic radiation surface 130a (bottom surface 23) of the ultrasonic-wave transmitter/receiver 130, the directivity characteristics of ultrasonic waves can be reliably widened.
(11) According to the present embodiment, the permanent magnet 141, which is the first magnetic material, is arranged on the upper surface 123a of the acoustic window 123, and the metal plate 142, which is the second magnetic material, is arranged on the bottom surface 23 of the ultrasonic-wave transmitter/receiver 130. In this case, the force that attracts the attachment 120 and the ultrasonic-wave transmitter/receiver 130 (the magnetic force of the permanent magnet 141) mainly acts in the same direction as the direction that pulls the ultrasonic-wave transmitter/receiver 130 and the attachment 120 out of the water. Therefore, it is possible to reliably prevent the attachment 120 from falling off from the ultrasonic wave transmitter/receiver 130.
(12) According to the present embodiment, since the inner wall surface of the opening hole 125 provided in the acoustic window 123 is inclined with respect to the lower surface 123b of the acoustic window 123, when the ultrasonic waves pass through the opening hole 125, the directional angle of ultrasonic waves becomes wider. If the inner wall surface of the opening hole 125 is arranged at the right angle to the lower surface 123b of the acoustic window 123, then the directional angle of the ultrasonic waves passing through the opening hole 125 tends to be slightly narrowed.

Each of the above embodiments may be modified as follows.
The acoustic window 51 of the first embodiment may be selected from among various types of acoustic windows of which the opening hole is different in inner diameter, shape, or the like. Similarly, the acoustic lens 81 of the second embodiment may be selected from among various types of acoustic lenses which are different in diameter of the flat surfaces, height from the center to the apex of the flat surface, shape of the convex surfaces, or the like.
According to the attachments 30, 60 of the first and second embodiments, the buoyant bodies 41, 71 and the holding members 31, 61 are formed separately, but the buoyant bodies 41, 71 may be integrally formed with the holding members 31, 61. By doing so, the number of parts of the attachment is reduced, thus making it possible to reduce the manufacturing cost of the attachment.
The opening holes 52, 125 provided in the acoustic windows 51, 123 of the first and third embodiments have a circular shape. However, they may have other shapes such as an elliptical shape, a polygonal shape, or the like.
According to the above second embodiment, the bottom portion 62 of the holding member 61 is provided with four-water supply/discharge holes 67. However, the number of water supply/discharge holes 67 may be five or more, or three or less. On the contrary, no such a hole may be provided. Also, the water supply/discharge hole 67 is formed by widening a part of the fitting hole 66. However, it may be a hole independent of the fitting hole 66.
According to the above third embodiment, the permanent magnet 141 is the first magnetic material provided on the attachment 120, and the metal plate 142 is the second magnetic material provided on the ultrasonic-wave transmitter/receiver 130. However, the first magnetic material provided on the attachment 120 may be a metal plate, and the second magnetic material provided on the ultrasonic-wave transmitter/receiver 130 may be a permanent magnet. Also, both the first magnetic material and the second magnetic material may be permanent magnets. Further, the first and second magnetic materials may be omitted.
According to the third embodiment, the permanent magnet 141, which is the first magnetic material, is provided on the upper surface 123a of the acoustic window 123, and the metal plate 142, which is the second magnetic material, is provided on the bottom surface 23 of the ultrasonic-wave transmitter/receiver 130. However, it is possible to provide the first magnetic material on the inner peripheral surface 124a (see FIGS. 12 and 13) of the holding recess 124 of the holding member 121 and to provide the second magnetic material on the outer peripheral surface 24 of the ultrasonic-wave transmitter/receiver 130. Also, the second magnetic material may be provided within the groove 25 formed on the outer peripheral surface 24. Further, the first magnetic material may be provided on both the upper surface 123a of the acoustic window 123 and on the inner peripheral surface 124a of the holding recess 124, and, in addition, the second magnetic material may be provided on both the bottom surface 23 and the outer peripheral surface 24 of the ultrasonic wave transmitter/receiver 130. Furthermore, the second magnetic material may be provided inside the ultrasonic-wave transmitter/receiver 130.
According to the above third embodiment, three pieces of the permanent magnet 141 are provided on the acoustic window 123, but the number of permanent magnets 141 may be five or more, or may be one or more and three or less. Further, the permanent magnet 141 is a piece-shaped permanent magnet having a circular shape in planner view but may be a sheet-shaped permanent magnet (magnet sheet).
According to the third embodiment, the permanent magnet 141 is embedded in the acoustic window 123. However, the permanent magnet 141 may protrude from the upper surface 123a of the acoustic window 123. Also, the permanent magnet 141 is embedded in the acoustic window 123 with its surface (upper surface) being exposed to the upper surface 123a. However, it may be completely embedded in the acoustic window 123. Furthermore, the permanent magnet 141 is fixed to the acoustic window 123 with an adhesive. However, it may be fixed to the acoustic window 123 using a screw or the like.

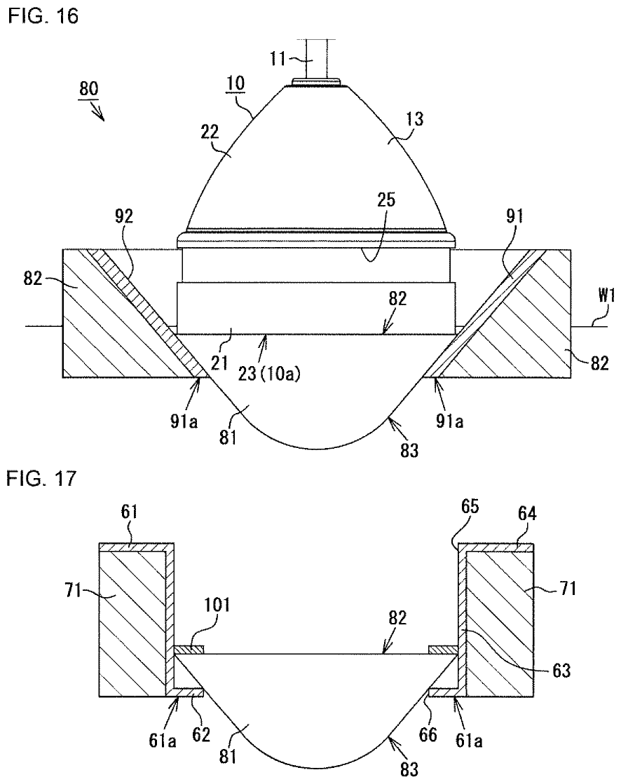

As shown in FIG. 16, the holding member 91 is provided with a fitting hole 92 for fitting the convex surface 83 of the acoustic lens 81 with the flat surface 82 facing up, so as to protrude downward from the bottom surface 91a of the holding member 91. Then, the fitting hole 92 may be formed such that the inner diameter gradually increases as it goes upward. With this configuration, the acoustic lens 81 is held by the holding member 91 in a state where a part of the inclined surface forming the convex surface 83 is in surface contact with the inner side surface of the fitting hole 92, thus making it easier to place the ultrasonic-wave transmitter/receiver 10 into the fitting hole 92.
According to the second embodiment, the acoustic lens 81 is placed in the holding recess 65 of the holding member 61. However, it is preferably fixed to the holding member 61 by fitting or adhering. Suppose it is not fixed to the holding member 61. In that case, when the ultrasonic-wave transmitter/receiver 10 is lifted, the attached acoustic lens 81 will also be lifted together with the ultrasonic-wave transmitter/receiver 10. Thus, there is a risk of the acoustic lens 81 dropping into the water.

Also, as a fixing mode of the acoustic lens 81, for example, as shown in FIG. 17, an annular mounting fixture 101 may be fixed on the inner peripheral surface of the holding recess 65 of the holding member 61 so that the mounting fixture 101 presses the outer peripheral surface of the flat surface 82 of the acoustic lens 81 fitted into the fitting hole 66. In this way, the acoustic lens 81 is firmly fixed while being inserted between the holding member 61 and the mounting fixture 101 so that the acoustic lens 81 can be securely held and fixed.

Further, as shown in FIG. 18, it is possible to penetrate a screw 114 (fastening member) through a through-hole 113 provided on a cylindrical portion 112 of a holding member 111, so as to let the tip of the screw 114 passing through the through-hole 113 fit into a groove 25 formed on the outer peripheral surface 24 of the ultrasonic-wave transmitter/receiver 10. In this case, the screw 114 fitted into the groove 25 makes it possible to prevent the case 13 (ultrasonic-wave transmitter/receiver 10) and the acoustic lens 81 located on its lower side from coming off, thus making it possible to securely hold and fix the ultrasonic-wave transmitter/receiver 10 and the acoustic lens 81. Instead of using the screw 114, the second magnetic material (e.g., a permanent magnet) may be provided in the groove 25, and the first magnetic material (e.g., a metal plate) may be provided on the cylindrical portion 112, at a position facing the second permanent magnet. Even in this case, the permanent magnet and the metal plate are closely attracted to each other so as to prevent the case 13 and the acoustic lens 81 from coming off, thus making it possible to securely fix and hold the ultrasonic wave transmitter/receiver 10 and the acoustic lens 81. In addition, if the screw 114 is not used, the through-hole 113 and the groove 25 may not be provided, either.
According to the embodiments described above, respectively, the case 13 of the ultrasonic-wave transmitter/receivers 10, 103 is formed by joining the upper case 22 to the lower case 21. However, it may be integrally formed.
According to the embodiments described above, respectively, the attachments 30, 60 and 120 are used for a fish finder. However, they may be used for a measuring device such as a depth sounder for measuring the water depth.

Besides the technical ideas of the present invention, as described above, other technical ideas to be understood are described hereinafter.
(1) An attachment for an ultrasonic-wave transmitter/receiver according to the second aspect of the present invention characterized in that the holding member is provided with a fitting hole for fitting the convex surface of the acoustic lens with the flat surface facing up so as to protrude downward from the bottom surface of the holding member, wherein the fitting hole is formed such that its inner diameter gradually increases as it goes upward.
(2) An attachment for an ultrasonic-wave transmitter/receiver according to the second aspect of the present invention characterized in that the holding member is provided with a fitting hole for fitting the convex surface of the acoustic lens with the flat surface facing up so as to protrude downward from the bottom surface of the holding member, wherein a mounting fixture is fixed to the inner peripheral side of the holding member to press the flat surface of the acoustic lens fitted into the fitting hole.
(3) An attachment for the ultrasonic-wave transmitter/receiver according to the second aspect of the present invention, characterized in that the bottom portion of the holding member is provided with a fitting hole for fitting the convex surface of the acoustic lens with the flat surface facing up so as to protrude downward from the bottom surface of the holding member, wherein the water supply/discharge hole is formed by widening a part of the fitting hole, so that the acoustic radiation surface of the ultrasonic transducer and the flat surface of the acoustic lens are in close contact with each other via water.
(4) An attachment for an ultrasonic-wave transmitter/receiver according to the third aspect of the present invention, characterized in that the amount of deviation between the central axis of the opening hole and the central axis of the ultrasonic-wave transmitter/receiver is 2% or less of the outer diameter of the ultrasonic-wave transmitter/receiver.
(5) An attachment for an ultrasonic-wave transmitter/receiver according to any one of the first to ninth aspects of the present invention, characterized in that the buoyant body has buoyancy such that the water surface reaches the top of the directivity-characteristic changing member in a state where the ultrasonic-wave transmitter/receiver is not being held by the holding member. In this way, when the ultrasonic-wave transmitter/receiver is held by the holding recess, the acoustic radiation surface of the ultrasonic-wave transmitter/receiver is securely brought into contact with liquid (in this case, with water). Therefore, an air pocket does not hinder ultrasonic wave irradiation.

(6) An attachment for an ultrasonic-wave transmitter/receiver according to any one of the first to ninth aspects of the present invention, characterized in that a groove is formed on the outer peripheral surface so as to extend in the circumferential direction of the ultrasonic-wave transmitter/receiver, wherein a fastening member penetrating the holding member is fitted into the groove.

### DESCRIPTION OF THE REFERENCE NUMERALS

10, 130: Ultrasonic wave transmitter/receiver
10a, 130a: Acoustic radiation surface
11: Cable
12: Ultrasonic transducer
23: Bottom surface of the ultrasonic-wave transmitter/receiver
30, 60, 120: Attachment
31, 61, 91, 111, 121: Holding member
32a: Outer wall surface of the holding member
34, 65, 124: Holding recess
41, 71, 122: Buoyant body
51, 123: Acoustic window as the directivity-characteristic changing members
52: Opening hole of the acoustic window
81: Acoustic lens as the directivity characteristic changing member
82: Flat surface
83: Convex surface
123a: Top surface of the acoustic window
141: Permanent magnet as the first magnetic material
142: Metal plate as the second magnetic material

1. An attachment to be attached to an ultrasonic-wave transmitter/receiver, which is suspended from a cable, and houses an ultrasonic transducer in the state of being molded for transmitting and receiving the ultrasonic waves and whose bottom surface is an acoustic radiation surface characterized in that the attachment comprises: a cup-shaped holding member having a holding recess for detachably holding the ultrasonic-wave transmitter/receiver; a buoyant body made of a material having a specific gravity less than that of water, which is provided so as to surround the holding member from the outer peripheral side to keep the ultrasonic-wave transmitter/receiver horizontal by the buoyant force which acts on itself; and a directivity-characteristic changing member arranged on the acoustic radiation surface side of the ultrasonic-wave transmitter/receiver, thus changing the directivity characteristic of the ultrasonic waves emitted from the acoustic radiation surface.

2. An attachment for an ultrasonic-wave transmitter/receiver according to claim 1, characterized in that the directivity-characteristic changing member is an acoustic lens having a flat surface and a convex surface located on its opposite side.

3. An attachment for an ultrasonic-wave transmitter/receiver according to claim 1, characterized in that the directivity-characteristic changing member is an acoustic window used in a state where the ultrasonic-wave transmitter/receiver is mounted, wherein the acoustic window is made of a soundproof material, having an opening hole smaller in area than the acoustic radiation surface.

4. An attachment for an ultrasonic-wave transmitter/receiver according to claim 3, characterized in that a first magnetic material is provided on at least either one of the holding member and the acoustic window, and a second magnetic material that attracts the first magnetic material is provided at a position facing the first magnetic material in the ultrasonic-wave transmitter/receiver, wherein at least either one of the first and second magnetic materials is a permanent magnet.

5. An attachment for an ultrasonic-wave transmitter/receiver according to claim 4, characterized in that a plurality of the first magnetic materials is spaced apart from each other around the opening hole of the acoustic window.

6. An attachment for an ultrasonic-wave transmitter/receiver according to claim 3, characterized in that the holding member, the buoyant body and the acoustic window are made of foamed polyethylene and integrally formed.

7. An attachment for an ultrasonic-wave transmitter/receiver according to claim 1, characterized in that the directivity-characteristic changing member is detachably held to the holding member and is selected from among various types of directivity-characteristic changing members of which at least one of dimensions and shape is different from each other.

8. An attachment for an ultrasonic-wave transmitter/receiver according to claim 1, characterized in that the buoyant body is integrally formed with the holding member.

9. An attachment for an ultrasonic-wave transmitter/receiver according to claim 1, characterized in that the holding recess holds the directivity-characteristic changing member on its lower side and houses and holds the ultrasonic-wave transmitter/receiver on its upper side, wherein the buoyant body is attached so as to surround the outer wall surface of the holding member.
